(19) United States
(12) Patent Application Publication
(10) Pub. No.: US 2023/0031215 A1
(43) Pub. Date: Feb. 2, 2023

(54) LONGITUDINAL REINFORCEMENT FOR A ROCKER PANEL BEAM OF A MOTOR VEHICLE

(71) Applicant: PSA AUTOMOBILES SA, Poissy (FR)

(72) Inventors: Bernard PATOUT, ARCEY (FR); Sebastien MAURICE, SOCHAUX (FR); Baye DIAW, COURCELLES LES MONTBELIARD (FR); Ludovic MERESSE, ARCEY (FR); Marc PERU, CHATENAY MALABRY (FR)

(21) Appl. No.: 17/790,930

(22) PCT Filed: Jan. 20, 2021
(86) PCT No.: PCT/FR2021/050103

§ 371 Date: Jul. 5, 2022

(30) Foreign Application Priority Data
Jan. 27, 2020 (FR) 2000783

(51) Int. Cl. B62D 25/02; B62D 25/04; B62D 27/02; B62D 25/20

(52) U.S. Cl. CPC B62D 25/025; B62D 25/04; B62D 27/023; B62D 25/2036

(57) ABSTRACT

Motor vehicle body structure (3), comprising, on each lateral side: a rocker panel beam (15) forming an internal space of the beam (15); and a longitudinal reinforcement (21) positioned in the interior space of the beam (15); the longitudinal reinforcement (21) extending from a centre pillar (9) to an A-pillar (7) and having an angled front portion (25) housed in the A-pillar (7).

### CROSS-REFERENCE TO RELATED APPLICATIONS

The present application is the US National Stage under USC § 371 of International Application No. PCT/FR2021/050103, filed Jan. 20, 2021 which claims the priority of French application 2000783 filed on Jan. 27, 2020, the content (text, drawings and claims) both being incorporated here by reference.

### BACKGROUND

The invention relates to the field of motor vehicles, and more particularly to motor vehicle body structures.

Motor vehicles comprise a body structure reinforced to withstand impacts. It is therefore known to reinforce the rocker panel beams using reinforcing elements, so as to improve the resistance of the body during the various frontal or side impacts to which the vehicle may be subjected.

In particular, motor vehicles with electric traction comprise traction batteries positioned at the rear of the vehicle. These batteries bring additional mass to the rear of the vehicle, which affects the behavior of the vehicle during a frontal impact. Indeed, this increase in the mass of the vehicle leads to an increase in the energy to be absorbed during an impact on the front of the vehicle and causes additional damage to the A-pillars. It therefore becomes necessary to add one or more additional reinforcements to the rocker panel beams and/or to the A-pillars of an electric traction motor vehicle.

FR3011801B1 discloses a motor vehicle structure, and more particularly a reinforced rocker panel beam structure, capable of deforming in the event of an impact. The beam comprises an inner spar and an outer spar forming an internal space, with at least one longitudinal reinforcement positioned in said internal space. This reinforced rocker panel beam structure has the advantage of being light and having a simple construction in that the reinforcement has a constant cross-section allowing it to be produced by profiling by rollers. However, it does not make it possible to meet the impact resistance requirements when the vehicle is equipped with traction batteries forming a significant additional mass at the rear.

### SUMMARY

The object of the invention is to overcome at least one of the drawbacks of the above-mentioned prior art. More particularly, the object is to improve the impact resistance of a vehicle body structure penalized by an addition of significant mass at the rear, more particularly during a frontal impact.

To this end, a motor vehicle body structure is disclosed, comprising, on each lateral side: a rocker panel beam forming an internal space of the beam; and a longitudinal reinforcement positioned in the internal space of the beam; wherein the longitudinal reinforcement extends from a center pillar to an A-pillar and has an angled front portion housed in said A-pillar.

According to an advantageous embodiment, the rocker panel beam is formed by an inner spar and an outer spar assembled together, and the longitudinal reinforcement is housed in said inner spar.

According to an advantageous embodiment, the longitudinal reinforcement has an inverted L-shaped cross-section with a vertical core and an upper horizontal flange.

According to an advantageous embodiment, the inner spar has a horizontal U-shaped cross-section with a vertical core, an upper horizontal flange and a lower horizontal flange, the vertical core of the longitudinal reinforcement being against the vertical core of the internal spar, and the upper horizontal flange of the longitudinal reinforcement being against the upper horizontal flange of the inner spar.

According to an advantageous embodiment, the inverted L-shaped section of the longitudinal reinforcement and the horizontal U-shaped section of the inner spar are present in the A-pillar.

Advantageously, the inverted L-shaped section of the angled front portion of the longitudinal reinforcement has a central core and a rear vertical flange. The horizontal U-shaped section of a front portion of the inner spar, located in the A-pillar, comprises a central core and two front and rear vertical flanges, the rear vertical flange of the longitudinal reinforcement being in contact with the rear vertical flange of the inner spar.

According to an advantageous embodiment, the vertical core of the longitudinal reinforcement is embossed by stamping.

“Embossing” means a printing, by stamping, of patterns on the vertical and/or central core of the longitudinal reinforcement.

According to an advantageous embodiment, the embossing of the vertical core of the longitudinal reinforcement forms zones of contact and attachment with the vertical core of the inner spar.

According to an advantageous embodiment, the vertical core of the longitudinal reinforcement comprises at least five openings distributed longitudinally along said longitudinal reinforcement.

According to an advantageous embodiment, the angled front portion in the A-pillar comprises, at an upper end, a horizontal partition of said A-pillar.

According to an advantageous embodiment, the horizontal partition is attached to the rest of the longitudinal reinforcement.

Advantageously, the rocker panel beam comprises additional reinforcements preferably positioned in the internal space of the beam.

The features of the rocker beam panel are advantageous in that they make it possible to improve the resistance of the body structure, and more particularly, of the rocker panel beams of the vehicle, during a frontal impact. They also make it possible to improve the resistance of the A-pillars of the vehicle during a frontal impact. In addition, the longitudinal reinforcement is particularly useful when it comes to a motor vehicle with electric traction, with a large mass added to the rear. Since the longitudinal reinforcement becomes pressed against an outer face of the inner spar, it takes up little space and makes it possible to retain the pre-existing reinforcements of the vehicle. This longitudinal reinforcement also makes it possible to retain the basic structure of the beam, without requiring the development of a beam structure specific to electric traction vehicles. Finally, this longitudinal reinforcement, and rocker beam panel with the reinforcement, is easy and inexpensive to produce, with techniques and materials known to those skilled in the art.

Other features and advantages of the longitudinal reinforcement will be better understood with the aid of the description and the drawings.

### BRIEF DESCRIPTION OF THE DRAWINGS

FIG. 1 is a perspective view of a motor vehicle structure;

FIG. 2 shows a perspective view of a longitudinal reinforcement;

FIG. 3 shows a view of an inner spar of a rocker panel beam with the longitudinal reinforcement of FIG. 2, and additional reinforcements.

### DETAILED DESCRIPTION

The examples described below are given by way of indication, but other applications or embodiments of the claimed invention not described can be envisaged.

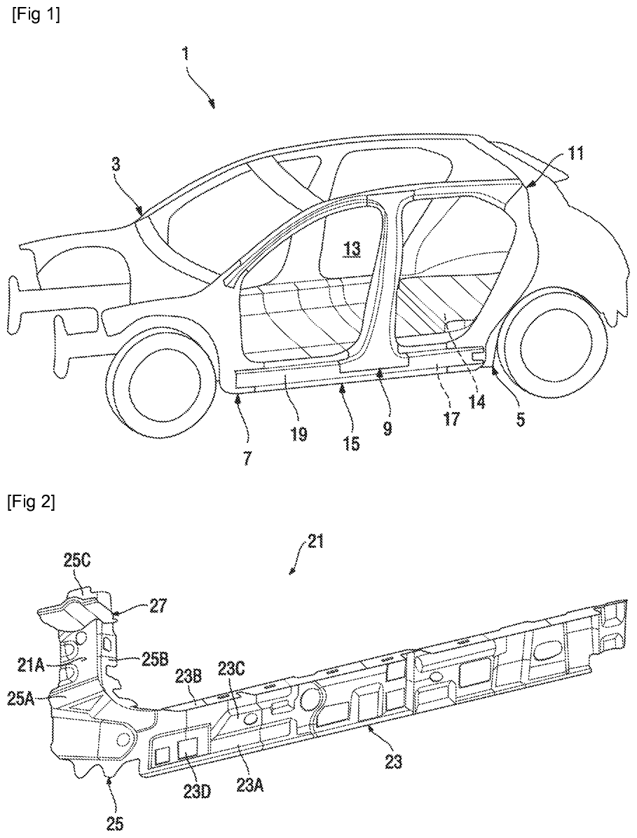

FIG. 1 shows a perspective view of a motor vehicle structure.

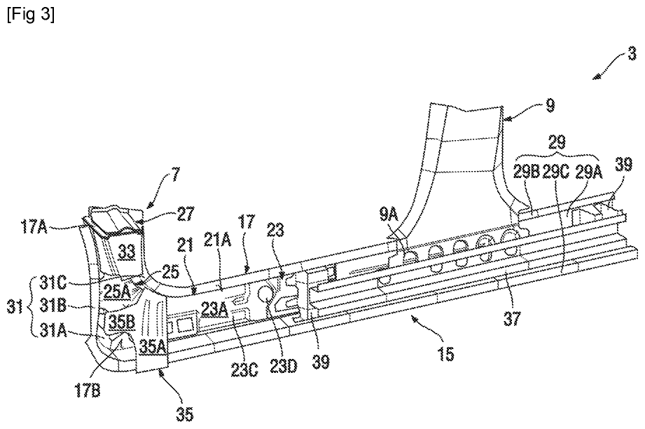

The motor vehicle 1 comprises a generally metallic body structure 3, with two lateral sides 5. At each of the lateral sides 5 are located, from the front to the rear of the vehicle 1, an A-pillar 7, a center pillar 9, then a rear pillar 11, the pillars (7, 9, 11) serving in particular to compartmentalize a passenger compartment 13 of the vehicle 1. In the case of a vehicle 1 with electric traction, traction batteries 14 are positioned at the rear of the vehicle 1, between the rear pillars 11. In addition, a rocker panel beam 15 extends between the A-pillar 7 and the rear pillar 11 and on each side 5 of the vehicle 1, at the rocker panel. Each beam 15 is formed by an inner spar 17 and an outer spar 19 (the outer spar 19 being visible only in this figure) assembled to each other so as to form an internal space of the beam 15. The internal space accommodates a reinforcement, illustrated in FIGS. 2 and 3 and detailed below, with a view to reinforcing the structure of the beams 15 and of the A-pillars 7 during a frontal impact. This reinforcement is particularly useful in the presence of the additional mass generated by the traction batteries 14, the mass being liable to cause additional damage to the structure 3 during a frontal impact.

FIG. 2 shows a perspective view of a longitudinal reinforcement.

The longitudinal reinforcement 21 comprises an elongated rear portion 23 and an angled front portion 25. The longitudinal reinforcement 21 has an L-shaped cross-section inverted by 180° in each of the rear 23 and front 25 portions. Thus, the rear portion 23 of said reinforcement 21 has a vertical core 23A and an upper horizontal flange 23B. Advantageously, the vertical core 23A of the longitudinal reinforcement 21 has an embossing produced by stamping. “Embossing” means that the vertical core 23A has bosses forming zones of contact and attachment to the inner spar (not visible in this figure). Thus, the vertical core 23A has zones 23C forming bumps and hollows. In addition, the vertical core 23A comprises openings 23D, at least five in number, that are distributed longitudinally along the longitudinal reinforcement 21.

The angled front portion 25 of the longitudinal reinforcement 21 has the inverted L-shaped cross-section, and forms a central core 25A with a rear vertical flange 25B. The central core 25A of the angled front portion 25 may further have the embossing previously described for the vertical core 23A. Optionally, at an upper end 25C of the angled front portion 25, there is a horizontal partition 27 of the A-pillar (the A-pillar not being visible in this figure), attached to the rest of the longitudinal reinforcement 21, and, more particularly, to an outer face 21A of said reinforcement 21. This horizontal partition 27 further has a bump along a longitudinal section of said partition 27.

FIG. 3 shows a view of the longitudinal reinforcement mounted in the inner spar of the rocker panel beam, with additional reinforcements. Only the inner spar of the rocker panel beam is shown in this figure.

The inner spar 17 of the beam 15 has an elongated rear portion 29 and an angled front portion 31. The rear portion 29 of the inner spar 17 has a horizontal U-shaped cross-section with a vertical core 29A, an upper horizontal flange 29B and a lower horizontal flange 29C. The angled front portion 31 of the inner spar 17 also has a horizontal U-shaped section, with a central core 31A and two front 31B and rear 31C vertical flanges. This angled front portion 31 of the inner spar 17 forms a lower part of the A-pillar 7.

The longitudinal reinforcement 21 is positioned in the internal space of the beam 15 and, more particularly, in the inner spar 17 of the beam 15. The longitudinal reinforcement 21 extends from the A-pillar 7 to the center pillar 9, the reinforcement 21 being visible through orifices 9A positioned in the center pillar 9. The longitudinal reinforcement 21 is advantageously attached to an outer face 17B of the inner spar 17. Thus, the angled front portion 25 of the longitudinal reinforcement 21 is positioned in the angled front portion 31 of the inner spar 17, the angled front portion 25 of the reinforcement 21 therefore being located in the A-pillar 7 of the body structure 3. Thus, the inverted L-shaped section of the longitudinal reinforcement 21 and the horizontal U-shaped section of the inner spar 17 are present in the A-pillar 7.

The vertical core 23A of the rear portion 23 of the longitudinal reinforcement 21 is positioned against the vertical core 29A of the rear portion 29 of the inner spar 17. In addition, the upper horizontal flange (not visible in this figure) of the rear portion 23 of the longitudinal reinforcement 21 is positioned against the upper horizontal flange 29B of the rear portion 29 of the inner spar 17. Advantageously, the contact and attachment zones 23C found on the vertical core 23A of the longitudinal reinforcement 21 come into contact with the vertical core 29A of the inner spar 17. In the same way, the central core 25A of the horizontal front portion 25 of the longitudinal reinforcement 21 is positioned against the central core 31A of the front portion 31 of the inner spar 17. In addition, the rear vertical flange (not visible in this figure) of the front portion 25 of the longitudinal reinforcement 21 is positioned against the rear vertical flange 31C of the front portion 31 of the inner spar 17.

The horizontal partition 27, positioned at the upper end (not visible in this figure) of the angled front portion 25 of the longitudinal reinforcement 21, extends between the inner 17 and outer spars of the beam 15. It extends above a front reinforcement 33, the reinforcement 33 having a horizontal U-shaped cross section and extending from an upper end 17A of the inner spar 17, in the direction of the outer spar. The beam 15 further comprises a lower front reinforcement 35 positioned in the angle of the angled front portion 31 of the inner spar 17. This lower front reinforcement 35 has a T shape, with a vertical portion 35A attached to the upper 29B and lower 29C horizontal flanges of the inner spar 17 and a horizontal portion 35B that extends from said vertical portion 35A toward the front vertical flange 31B of the angled front portion 31. This lower front reinforcement 35 improves the resistance of the A-pillar 7 to frontal impacts.

The beam 15 further comprises a rear section reinforcement 37 that extends from the center pillar 9 toward the rear pillar (not visible in this figure) of the body structure 3. This rear section reinforcement 37 has a horizontal U-shaped cross-section, attached to the inner spar 17 by two compression reinforcements 39. These reinforcements (37, 39) are intended to improve the damping of side impacts.

1. A motor vehicle body structure comprising, on each lateral side:
a rocker panel beam forming an internal space of the beam; and
a longitudinal reinforcement positioned in the internal space of the beam;
wherein, the longitudinal reinforcement extends from a center pillar to an A-pillar of said vehicle and has an angled front portion housed in said A-pillar.

2. The motor vehicle body structure according to claim 1, wherein the rocker panel beam is formed by an inner spar and an outer spar assembled together, and the longitudinal reinforcement is housed in said inner spar.

3. The motor vehicle body structure according to claim 1, wherein the longitudinal reinforcement has an inverted L-shaped cross-section with a vertical core and an upper horizontal flange.

4. The motor vehicle body structure according to claim 11, wherein the inner spar has a horizontal U-shaped cross-section with a vertical core, an upper horizontal flange and a lower horizontal flange, the vertical core of the longitudinal reinforcement being against the vertical core of the inner spar, and the upper horizontal flange of the longitudinal reinforcement being against the upper horizontal flange of the inner spar.

5. The motor vehicle body structure according to claim 4, wherein the inverted L-shaped section of the longitudinal reinforcement and the horizontal U-shaped section of the inner spar are present in the A-pillar.

6. The motor vehicle body structure according to claim 3, wherein the vertical core of the longitudinal reinforcement is embossed by stamping.

7. The motor vehicle body structure according to claim 12, wherein the embossing of the vertical core of the longitudinal reinforcement forms zones of contact and attachment with the vertical core of the inner spar.

8. The motor vehicle body structure according to claim 3, wherein the vertical core of the longitudinal reinforcement comprises at least five openings distributed longitudinally along said longitudinal reinforcement.

9. The motor vehicle body structure according to claim 1, wherein the angled front portion in the A-pillar comprises, at an upper end, a horizontal partition of said A-pillar.

10. The motor vehicle body structure according to claim 9, characterized in that the horizontal partition is attached to the rest of the longitudinal reinforcement.

11. The motor vehicle body structure according to claim 2, wherein the longitudinal reinforcement has an inverted L-shaped cross-section with a vertical core and an upper horizontal flange.

12. The motor vehicle body structure according to claim 4, wherein the vertical core of the longitudinal reinforcement is embossed by stamping.
